(19) United States
(12) Patent Application Publication
(10) Pub. No.: US 2018/0105182 A1
(43) Pub. Date: Apr. 19, 2018

(54) METHOD AND SYSTEM TO IMPROVE SENSOR ACCURACY FOR ADAS SYSTEMS USING GEOGRAPHICAL INFORMATION

(71) Applicant: TOYOTA JIDOSHA KABUSHIKI KAISHA, Toyota-shi (JP)

(72) Inventors: BaekGyu Kim, Mountain View, CA (US); Yusuke Kashiba, Mountain View, CA (US); Shinichi Shiraishi, Mountain View, CA (US)

(21) Appl. No.: 15/293,245

(22) Filed: Oct. 13, 2016

(51) Int. Cl. B60W 50/00; B60W 30/12; B60W 30/16; G01S 19/42

(52) U.S. Cl. CPC B60W 50/00; B60W 30/12; B60W 30/16; G01S 19/42; B60W 2520/06; B60W 2710/20; B60W 2550/408; B60W 2550/308; B60W 2550/302; B60W 2750/308; B60W 2520/10

(57) ABSTRACT

The disclosure includes embodiments for estimating whether local sensor data or remote sensor data is more accurate for a given geographical location of an ego vehicle. A method may include determining, based on Global Positioning System data (“GPS data”), whether the ego vehicle is located in a geographical region where local sensor data or remote sensor data is more accurate. The method may include retrieving a set of sensor data from a non-transitory memory. The set of sensor data may consist of the more accurate of the local sensor data and the remote sensor data. The method may include inputting the set of sensor data to the ADAS system. The method may include executing the ADAS system so that the ADAS system provides its functionality based on the set of sensor data that consists of the more accurate of the local sensor data and the remote sensor data.

### BACKGROUND

The specification relates to improving sensor accuracy for vehicle control systems using geographical information.

Vehicle control systems are becoming increasingly popular. One example of a vehicle control system is an Advanced Driver Assistance System (“ADAS system” if singular, “ADAS systems” if plural).

Proper functioning of ADAS systems depends on the availability of highly accurate sensor data. The more accurate the sensor data, the more accurate the function of the ADAS system relative to the intent of the design engineer for the vehicle or the ADAS system. The less accurate the sensor data, the less accurate the function of the ADAS system relative to the intent of the design engineer. Accordingly, there is a need to provide ADAS systems with the most accurate sensor data available.

### SUMMARY

Described are embodiments that include a system, method and a computer program product for providing sensor information to an ADAS system of an ego vehicle based on the geographic location of the ego vehicle as indicated by Global Positioning System (“GPS”) data sourced from a GPS unit.

In some embodiments, there may be two sources of sensor data. The first source of sensor data is local sensors of the ego vehicle. Sensor data provided via this first source is referred to herein as “local sensor data.” The second source of sensor data includes sensors of other vehicles that are remote from the ego vehicle. These remote vehicles may wirelessly transmit their sensor data to the ego vehicle via Dedicated Short Range Communication (“DSRC”) or any other wireless communication method. Sensor data provided via this second source is referred to herein as “remote sensor data.” In some situations, the local sensor data is more accurate than the remote sensor data. In other situations, the remote sensor data may be more accurate than the local sensor data.

The ego vehicle may include one or more of the following: a sensor decision system; an ADAS system; a sensor accuracy database; a DSRC antenna or some other wireless communication antenna; and a DSRC-compliant GPS unit.

The sensor decision system may determine whether to provide the ADAS system with local sensor data or remote sensor data based on the geographic location of the ego vehicle as indicated by the GPS data sourced from the DSRC-compliant GPS unit. For example, the sensor decision system may determine whether the local sensor data or the remote sensor data is more accurate based on the current geographic location of the ego vehicle (or substantially current geographic location of the ego vehicle) as described by the GPS data. In this way, the sensor decision system beneficially ensures that the most accurate sensor data is used by the ADAS system at any given time.

The sensor accuracy database may store accuracy data. See, e.g., FIG. 1B. The sensor accuracy database may be stored in a non-transitory memory of the vehicle or in a non-transitory memory of remote cloud server wirelessly accessible by the sensor decision system.

In some embodiments, the accuracy data may describe one or more geographical constraints that affect to the accuracy of the local sensor data and remote sensor data for different geographic regions. Examples of geographical constraints that may affect whether the local sensor data or remote sensor data will be more accurate include the following: the curvature effects to the accuracy of a forward sensor of the ego vehicle (e.g., a local sensor); the number of base stations in the geographic area; and the degree of signal interference and how this interference may affect the ability of the ego vehicle to receive remote sensor data via wireless transmission from one or more remote vehicles.

As mentioned in the preceding paragraph, the accuracy data may include geographical constraints for a plurality of geographical regions. Each geographical region described by the accuracy data may be assigned a region identifier (a “region ID”). A region ID may be a unique identifier for a particular geographic region. Each region ID may be associated with one or more geographical constraints. These geographical constraints may describe one or more factors which affect the accuracy of the local sensor data or the remote sensor data when the vehicle is present in this particular geographic region.

In some embodiments, the sensor decision system may store electronic map data that describes an electronic map. In some embodiments, the electronic map includes different regions. Each region has a unique region ID. The electronic map may be organized so that it receives GPS data as an input (or query) and outputs the region ID associated with that GPS data as a response to the input. In this way the electronic map may provide the sensor decision system with a region ID based on the GPS data provided by a DSRC-compliant GPS unit.

In some embodiments, the sensor accuracy database includes, for each geographical region, accuracy data that describes the relative accuracy of the local sensor data and remote sensor data based on the geographical constraints for that geographic region. The relative accuracy of the local sensor data and the remote sensor data may be quantified in terms of a minimum/maximum (“min/max”) percentage or probabilistic distributions.

There are several ways to quantify the relative accuracy of the local sensor data and the remote sensor data, one or more of which may be implemented by the sensor decision system when constructing the sensor accuracy database. One way to quantify the relative accuracy of the local sensor data and the remote sensor data is to statically analyze the geographical constraint to estimate the accuracy. For example, for a curvature of 45, a millimeter wave radar sensor may detect the forward vehicle at the probability of 0.3 to 0.4.

Another way to quantify the relative accuracy of the local sensor data and the remote sensor data is to gather log data transmitted from each vehicle that has passed a particular geographical region. The log data may describe relevant factors for the geographical region such as weather conditions that might affect sensor accuracy. For example, the log data may describe whether the geographical region is prone to fog or high humidity, either of which may adversely affect sensor accuracy and result in a pattern of less accurate sensor measurements while a vehicle is present in the geographical region.

Any other existing technique to quantify the relative accuracy of the local sensor data and the remote sensor data may be implemented by the sensor decision system when generating the sensor accuracy database.

The sensor accuracy database may include a first column of geographic regions indicated by a unique region ID and a second column that includes accuracy data that describes, for each region ID, whether the local or remote sensor data is generally more accurate. In this way each region ID may be associated with a different set of accuracy data that describes, for that region ID, whether the local sensor data or the remote sensor data is more accurate.

In some embodiments, the sensor decision system may include a sensor module. The sensor module may include code and routines that are operable, when executed by a processor of the vehicle, to cause the processor to execute one or more of the following steps: (1) execute one or more local sensors of the vehicle to generate local sensor data describing one or more sensor measurements recorded by the one or more local sensors; (2) store the local sensor data in a non-transitory memory of the vehicle; (3) query a communication unit of the vehicle to receive remote sensor data generated by one or more remote sensors of one or more remote vehicles that are adapted to wirelessly transmit the remote sensor data to the communication unit of the vehicle; and (4) store the remote sensor data in the non-transitory memory of the vehicle.

In some embodiments, the sensor decision system may include a region detection module. The region detection module may include code and routines that are operable, when executed by a processor of the vehicle, to cause the processor to execute one or more of the following steps: (1) cause the DSRC-compliant GPS unit to retrieve GPS data that describes the current location of the vehicle; (2) analyze the electronic map to determine which region ID is associated with the latitude and longitude coordinates described by the GPS data; (3) query the sensor accuracy database using the region ID to determine accuracy data for the region ID that describes whether local sensor data or remote sensor data is more accurate for the region ID; and (4) provide the accuracy data to a determination module of the sensor decision system.

In some embodiments, the determination module may include code and routines that are operable, when executed by a processor of the vehicle, to cause the processor to execute one or more of the following steps: (1) receive the accuracy data from the region detection module; (2) determine, based on the accuracy data, whether a local sensor data or remote sensor data is more accurate for the present geographic location of the vehicle; and (3) provide the most accurate of the local sensor data or the remote sensor data to an ADAS system of the vehicle.

In some embodiments, if the local sensor data and the remote sensor data are equally accurate and, responsive to this equality (or substantial equality), the determination module may decide to provide the local sensor data to the ADAS system since the accurate operation of the sensors which recorded the local sensor data is known to the determination module, and so, the determination module may determine that the local sensor data is more reliable for this example reason.

In some embodiments, the ego vehicle and one or more of the remote vehicles may be DSRC-equipped vehicles. A DSRC-equipped vehicle may include a vehicle that includes one or more of the following elements: a DSRC transceiver and any software or hardware necessary to encode and transmit a DSRC message; a DSRC receiver and any software or hardware necessary to receive and decode a DSRC message; and a DSRC-compliant Global Positioning System (a “DSRC-compliant GPS unit”).

A DSRC-compliant GPS unit can provide GPS data describing the location of a vehicle with lane-level accuracy. Lane level accuracy may mean that the location of a vehicle is described so accurately that the vehicle's lane of travel may be accurately determined when traveling under an open sky (e.g., plus or minus 1.5 meters of the actual location of the vehicle). A conventional GPS system is unable to determine the location of a vehicle with lane-level accuracy. For example, a typical lane of a roadway is approximately 3 meters wide. However, a conventional GPS system may only have an accuracy of plus or minus 10 meters relative to the actual location of the vehicle.

A DSRC-compliant GPS unit may include hardware that wirelessly communicates with a GPS satellite to retrieve GPS data that describes a location of a vehicle with a precision that is compliant with the DSRC standard. The DSRC standard requires that GPS data be precise enough to infer if two vehicles are in the same lane. A DSRC-compliant GPS unit may be operable to identify, monitor and track its two-dimensional position within 1.5 meters of its actual position 68% of the time under an open sky. Since lanes of a roadway are typically no less than 3 meters wide, whenever the two-dimensional error of the GPS data is less than 1.5 meters the sensor decision system described herein may analyze the GPS data provided by the DSRC-compliant GPS unit and determine what lane of the roadway the vehicle is traveling in based on the relative positions of vehicles on the roadway. In this way, the DSRC-compliant GPS unit may beneficially provide GPS data with lane-level accuracy, thereby enabling the sensor decision system to more accurately identify the region ID for the ego vehicle and determine whether the local sensor data or the remote sensor data is more accurate based on the geographic location of the ego vehicle at a known time.

In some embodiments, devices other than vehicles may be DSRC-equipped. These DSRC-equipped devices may be used to relay remote sensor data to the ego vehicle via a DSRC message. For example, a roadside unit (“RSU”) or any other communication device may be DSRC-equipped if it includes one or more of the following elements: a DSRC transceiver and any software or hardware necessary to encode and transmit a DSRC message; and a DSRC receiver and any software or hardware necessary to receive and decode a DSRC message.

The embodiments described herein may use wirelessly transmit remote sensor data to the ego vehicle via a wireless message such as a DSRC message or a Basic Safety Message (“BSM”).

In some embodiments, the sensor determination system may include code and routines that are operable, when executed by the processor of the vehicle, to execute one or more of the following steps: (1) determine regional information for the ego vehicle based on the GPS data and the electronic map (e.g., the regional information includes the region ID associated with the GPS data; the sensor decision system may provide the GPS data as a query to the electronic map and receive the regional information as a response to the query); (2) determine the accuracy data for the regional information (e.g., the sensor decision system may provide the regional information as a query to the sensor accuracy database; the sensor accuracy database may return accuracy data associated with the regional information as a response to the query; the accuracy data may describe whether local or remote sensor data is more accurate for the particular geographic region where the vehicle is presently located); (3) retrieve local or remote sensor data responsive to the accuracy data (if the local sensor data is more accurate, then the local sensor data is retrieved from the non-transitory memory of the ego vehicle; if the remote sensor data is more accurate, then the remote sensor data is retrieved from the non-transitory memory of the ego vehicle); and (4) provide the retrieved sensor data as an input to a selected ADAS system of the ego vehicle. The selected ADAS system may then be executed so that it may provide its functionality for the ego vehicle.

No other technologies utilize GPS data to determine whether to use local sensor data or remote sensor data when providing ADAS system functionality to a vehicle.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for an ego vehicle including an ADAS system, the method including: determining, based on GPS data, whether the ego vehicle is located in a geographical region where local sensor data or remote sensor data is more accurate; retrieving a set of sensor data from a non-transitory memory, where the set of sensor data includes of the more accurate of the local sensor data and the remote sensor data; inputting the set of sensor data to the ADAS system; and executing the ADAS system so that the ADAS system provides its functionality based on the set of sensor data that includes of the more accurate of the local sensor data and the remote sensor data. Other embodiments of this aspect include corresponding computer systems, apparatus, and computer programs recorded on one or more computer storage devices, each configured to perform the actions of the methods.

Implementations may include one or more of the following features. The method where the remote sensor data is transmitted to the ego vehicle by a remote vehicle. The method where the remote sensor data is transmitted to the ego vehicle by a RSU. The method where the remote sensor data is transmitted to the ego vehicle via a wireless message that is compliant with a DSRC standard. The method where the remote sensor data is transmitted to the ego vehicle via a full-duplex wireless message. The method where the remote sensor data is transmitted to the ego vehicle via a millimeter wave message. The method where the GPS data is retrieved by a DSRC-compliant GPS unit. The method where the GPS data has an accuracy of substantially plus or minus 1.5 meters of the actual location of the ego vehicle. Implementations of the described techniques may include hardware, a method or process, or computer software on a computer-accessible medium.

One general aspect includes a system including an ego vehicle, the ego vehicle including: an ADAS system; and an onboard vehicle computer system that is communicatively coupled to the ADAS system, the onboard vehicle computer system including a non-transitory memory storing computer code which, when executed by the onboard vehicle computer system causes the onboard vehicle computer system to: determine, based on GPS data describing a geographical location of the ego vehicle, whether the ego vehicle is located in a geographical region where local sensor data or remote sensor data is more accurate; retrieve a set of sensor data from the non-transitory memory, where the set of sensor data includes of the more accurate of the local sensor data and the remote sensor data; input the set of sensor data to the ADAS system; and execute the ADAS system so that the ADAS system provides its functionality based on the set of sensor data that includes of the more accurate of the local sensor data and the remote sensor data. Other embodiments of this aspect include corresponding computer systems, apparatus, and computer programs recorded on one or more computer storage devices, each configured to perform the actions of the methods.

Implementations may include one or more of the following features. The system where the remote sensor data is transmitted to the ego vehicle by a remote vehicle. The system where the remote sensor data is transmitted to the ego vehicle by an RSU. The system where the remote sensor data is transmitted to the ego vehicle via a wireless message that is compliant with a DSRC standard. The system where the remote sensor data is transmitted to the ego vehicle via a full-duplex wireless message. The system where the remote sensor data is transmitted to the ego vehicle via a millimeter wave message. The system where the remote sensor data is transmitted to the ego vehicle via a wireless network. The system where the GPS data has an accuracy of substantially plus or minus 1.5 meters of the actual location of the ego vehicle. Implementations of the described techniques may include hardware, a method or process, or computer software on a computer-accessible medium.

One general aspect includes a computer program product including a non-transitory memory of an onboard vehicle computer system of an ego vehicle storing computer-executable code that, when executed by a processor, causes the processor to: determine, based on GPS data describing a geographical location of the ego vehicle, whether the ego vehicle is located in a geographical region where local sensor data or remote sensor data is more accurate; retrieving a set of sensor data from the non-transitory memory, where the set of sensor data includes of the more accurate of the local sensor data and the remote sensor data; input the set of sensor data to an ADAS system of the ego vehicle; and execute the ADAS system so that the ADAS system provides its functionality based on the set of sensor data that includes of the more accurate of the local sensor data and the remote sensor data. Other embodiments of this aspect include corresponding computer systems, apparatus, and computer programs recorded on one or more computer storage devices, each configured to perform the actions of the methods.

Implementations may include one or more of the following features. The computer program product where the remote sensor data is transmitted to the ego vehicle by a remote vehicle. The computer program product where the remote sensor data is generated by a sensor set of a remote vehicle. The computer program product where the local sensor data is generated by a sensor set of the ego vehicle. Implementations of the described techniques may include hardware, a method or process, or computer software on a computer-accessible medium.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an operating environment for a sensor decision system according to some embodiments.

FIG. 1B is a block diagram illustrating a sensor accuracy database according to some embodiments.

FIG. 1C is a block diagram illustrating accuracy data according to some embodiments.

FIG. 1D is a block diagram illustrating a flow process for the sensor decision system according to some embodiments.

FIG. 1E is a block diagram illustrating a roadway environment for a sensor decision system according to some embodiments.

FIG. 2 is a block diagram illustrating an example computer system including a sensor decision system according to some embodiments.

FIG. 3 is a flowchart of an example method for estimating whether local sensor data or remote sensor data is more accurate based on a geographic location of an ego vehicle according to some embodiments.

FIG. 4A is a block diagram illustrating an example of BSM data according to some embodiments.

FIG. 4B is a block diagram illustrating an example of BSM data according to some embodiments.

FIG. 5 is a block diagram illustrating an example use case of the accuracy data according to some embodiments.

### DETAILED DESCRIPTION

A driver's vehicle may be referred to herein as an “ego vehicle.” Assume that the ego vehicle includes an ADAS system. The ego vehicle also includes a sensor set that captures local sensor data that describes the sensor measurements recorded by the sensor set. The ego vehicle may also receive remote sensor data recorded by the sensors of remote vehicles. Both the local sensor data and the remote sensor data may include data that describes a roadway environment that includes both the ego vehicle and one or more remote vehicles. Since the functionality provided by the ADAS system is dependent upon the accuracy of the sensor data utilized by the ADAS system when providing its functionality, it would be beneficial if the ADAS system were always provided with the most accurate sensor data available in any circumstance, whether it be the local sensor data or the remote sensor data. The ego vehicle may include a sensor decision system that solves this problem. Our research has shown that whether the local sensor data or the remote sensor data is more accurate depends on the geographic location of the ego vehicle at a known time. The sensor decision system described herein solves may execute steps including: (1) determining the geographic location of the ego vehicle at a specific time or time frame; (2) analyzing the geographic location of the ego vehicle to determine whether local sensor data or remote sensor data is more accurate for this particular geographic location; and (3) providing an ADAS system of the vehicle with the most accurate of the local sensor data and the remote sensor data.

The remote sensor data may be sourced from one or more remote sources.

Examples of remote sources include a remote vehicle and a roadside unit (“RSU”). The RSU may relay remote sensor data to the ego vehicle, for example, if the remote vehicle is outside of DSRC range of the ego vehicle. Optionally, the RSU may include a set of sensors that records its own remote sensor data which may then be related to the ego vehicle via DSRC or some other wireless communication protocol.

In some embodiments, the sensor decision system may provide a notification to a driver of the vehicle to inform them of which of the local sensor data and the remote sensor data is more accurate for a given time or time frame. The notification provided to the driver of the vehicle may include a visual notification such as a graphical user interface (“GUI”), an audio notification such as audio generated by one or more speakers or a combination of a visual notification and an audio notification provided simultaneously or contemporaneously.

The visual notification may be provided by a heads-up display unit or an electronic panel. The heads-up display unit may include a three-dimensional heads-up display unit such as the one described in U.S. patent application Ser. No. 15/080,433 filed on Mar. 24, 2016 and entitled “Wireless Data Sharing Between a Mobile Client Device and a Three-Dimensional Heads-Up Display Unit,” the entirety of which is herein incorporated by reference. The electronic panel may be an element of a head-unit or an infotainment system installed in the vehicle.

The audio notification may be provided by one or more speakers that are operated by the head-unit, infotainment system or navigation system of the vehicle.

### Examples of a Wireless Messages Including Remote Sensor Data

Vehicles are increasingly equipped with DSRC. A vehicle equipped with DSRC may be referred to as “DSRC-equipped.” A DSRC-equipped vehicle may include a DSRC antenna and any hardware of software necessary to send and receive DSRC messages, generate DSRC messages and read DSRC messages. For example, a DSRC-equipped vehicle may include any hardware or software necessary to receive a DSRC message, retrieve data included in the DSRC message and read the data included in the DSRC message.

The one or more wireless messages may include a DSRC message. There are many types of DSRC messages. One type of DSRC message is known as a BSM. DSRC-equipped vehicles broadcast a BSM at a regular interval. The interval may be user adjustable.

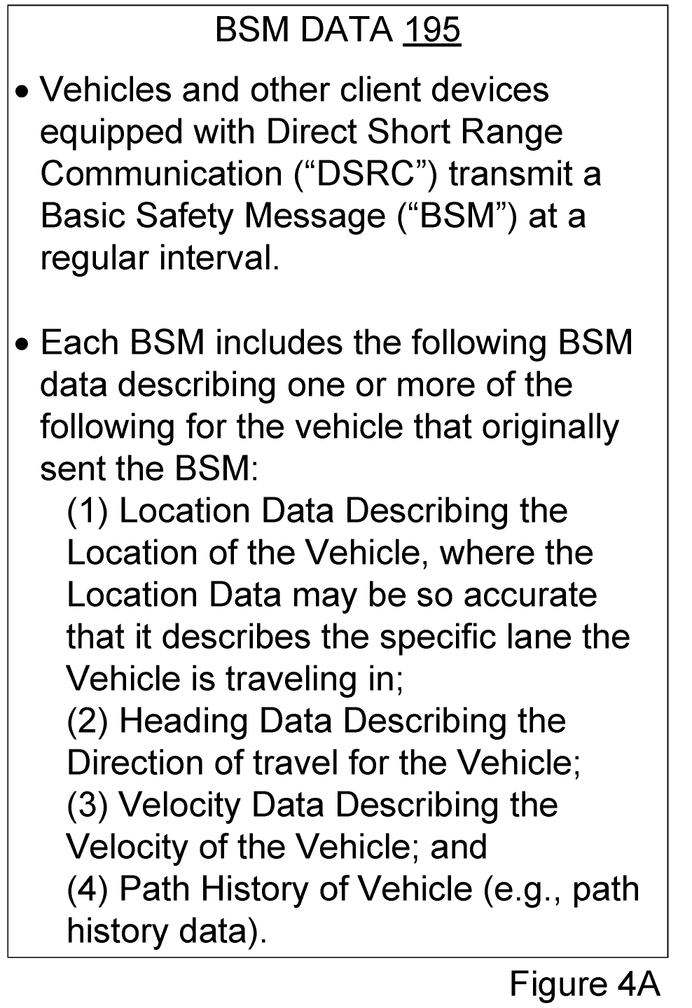

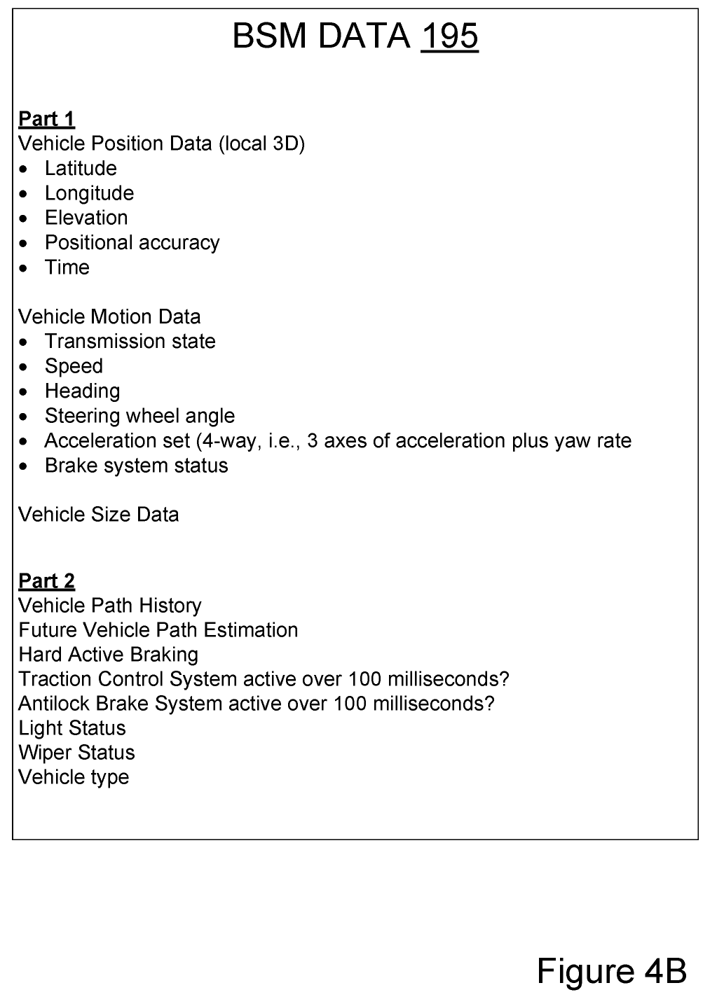

A BSM includes BSM data. The BSM data describes attributes of the vehicle that originally transmitted the BSM. Vehicles equipped with DSRC may broadcast BSMs at an adjustable rate. In some embodiments, the rate may be once every 0.10 seconds. The BSM includes BSM data that describes, among other things, one or more of the following: (1) the path history of the vehicle that transmits the BSM; (2) the speed of the vehicle that transmits the BSM; and (3) the GPS data (sometimes referred to as “global positioning system data” or “GPS data”) describing a location of the vehicle that transmits the BSM. FIGS. 4A and 4B, which are described below, depict examples of BSM data according to some embodiments.

In some embodiments, DSRC-equipped vehicles may probe other DSRC-equipped vehicles/devices along the roadway for information describing their current and future conditions, including their path history, future path and remote sensor data they may have received or generated. This information is described as “DSRC probe data.” DSRC probe data may include any data received via a DSRC probe or responsive to a DSRC probe.

A DSRC message may include DSRC-based data. The DSRC-based data may include BSM data or DSRC probe data. In some embodiments, the DSRC-based data included in a DSRC message may include BSM data or DSRC probe data received from a plurality of DSRC-equipped vehicles (or other DSRC-equipped devices). This BSM data or DSRC probe data may include an identifier of its source and the location of the source or any traffic events described by the BSM data or DSRC probe data.

In some embodiments, the DSRC-enabled vehicles will include a DSRC-compliant GPS unit. The BSM data or DSRC probe data may specify which lane a vehicle is traveling in as well as its speed of travel and path history. The BSM data or DSRC probe data may further specify one or more of the following: a velocity of the vehicle at one or more different times or one or more different locations; a heading of the vehicle at one or more different times or one or more different locations; and an acceleration of the vehicle at one or more different times or one or more different locations.

Another type of wireless message is a full-duplex wireless message described in U.S. patent application Ser. No. 14/471,387 filed on Aug. 28, 2014 and entitled “Full-Duplex Coordination System,” the entirety of which is herein incorporated by reference.

### Examples of Lane Level Accuracy

Vehicles are also increasingly manufactured to include GPS-based navigation systems. A GPS-based navigation system may provide navigation routes to a driver that are based on GPS data and knowledge about queue lengths along roadways.

Lane level accuracy may mean that the location of a vehicle is described so accurately that the vehicle's lane of travel may be accurately determined. In the context of the sensor decision system, lane level accuracy enables the sensor decision system to more accurately determine the region ID for the ego vehicle, and thus more accurately determine whether the local sensor data or the remote sensor data is more accurate at a given time or time frame. A conventional GPS system is unable to determine the location of a vehicle with lane-level accuracy. For example, a typical lane of a roadway is approximately 3 meters wide. However, a conventional GPS system may only have an accuracy of plus or minus 10 meters relative to the actual location of the vehicle.

A DSRC-compliant GPS unit can provide GPS data describing the location of a vehicle with lane-level accuracy. A DSRC-compliant GPS unit may include hardware that wirelessly communicates with a GPS satellite to retrieve GPS data that describes a location of a vehicle with a precision that is compliant with the DSRC standard. The DSRC standard requires that GPS data be precise enough to infer if two vehicles are in the same lane. The lane may be a lane of a roadway. A DSRC-compliant GPS unit may be operable to identify, monitor and track its two-dimensional position within 1.5 meters of its actual position 68% of the time under an open sky. Since lanes of a roadway are typically no less than 3 meters wide, whenever the two-dimensional error of the GPS data is less than 1.5 meters the sensor decision system described herein may analyze the GPS data provided by the DSRC-compliant GPS unit and determine what lane of the roadway the vehicle is traveling in based on the relative positions of vehicles on the roadway.

The sensor decision system described herein may determine a region ID for the remote vehicle based on GPS data provided by a DSRC-compliant GPS unit.

### ADAS System

Examples of an ADAS system may include one or more of the following elements of an ego vehicle: an adaptive cruise control (“ACC”) system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane departure warning system; a pedestrian protection system; a traffic sign recognition system; a turning assistant; and a wrong-way driving warning system.

The ADAS system may also include any software or hardware included in the ego vehicle that makes that ego vehicle be an autonomous vehicle or a semi-autonomous vehicle.

### Example Overview

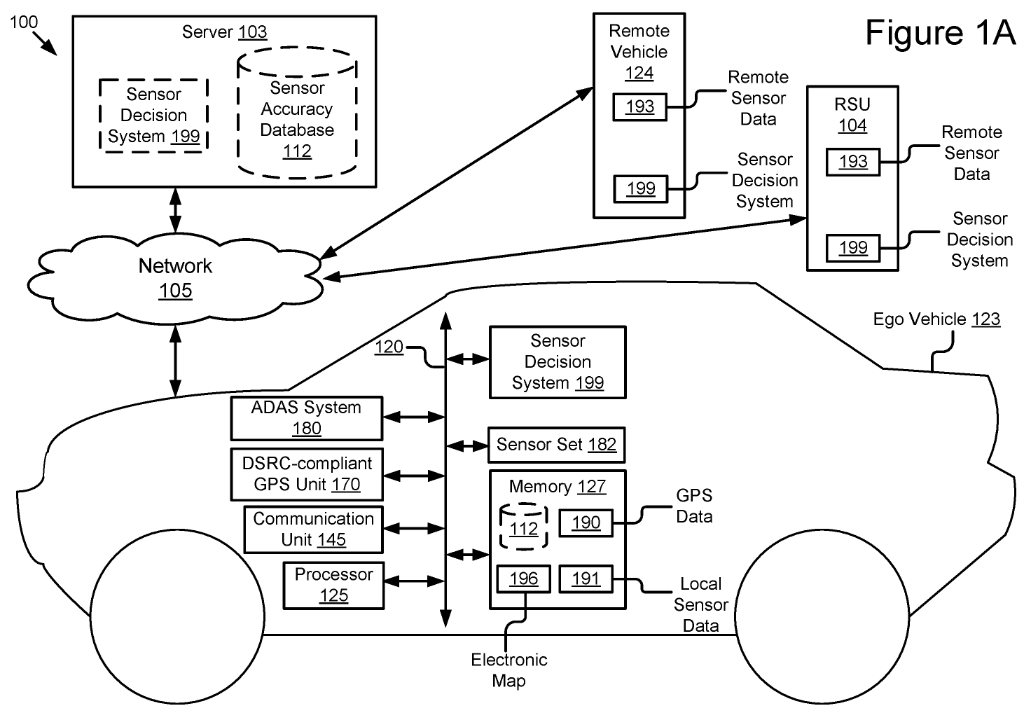

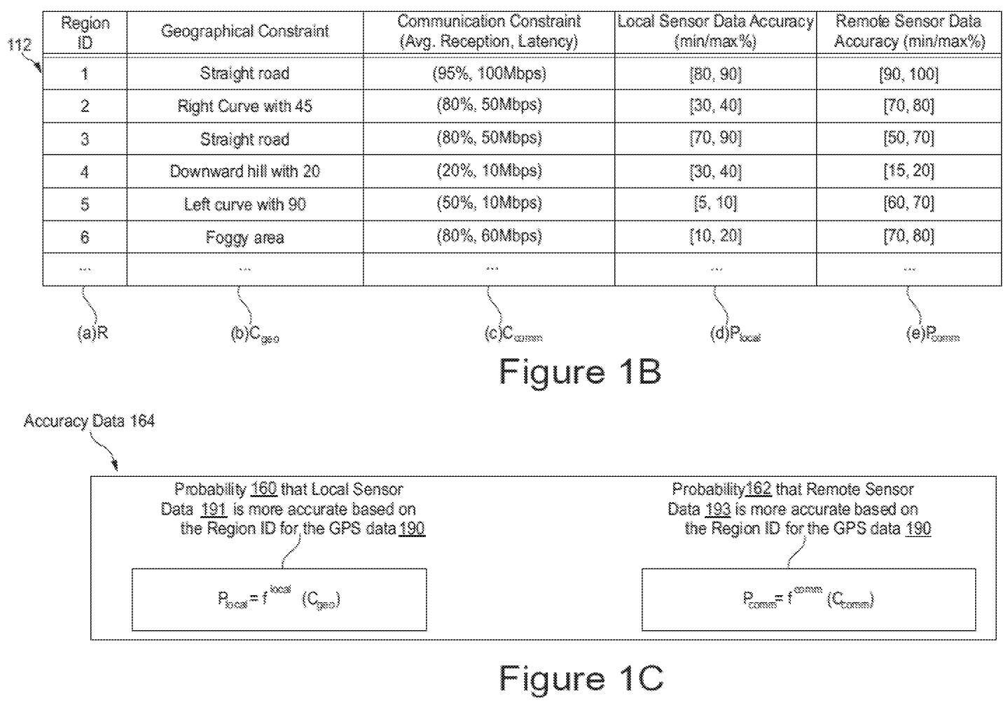

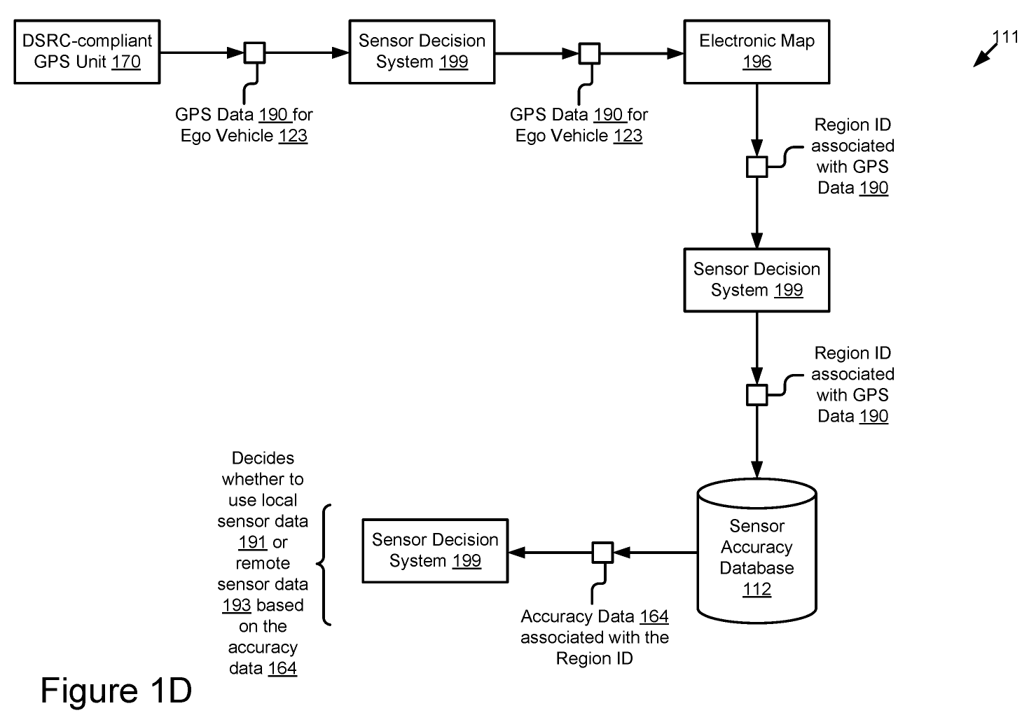

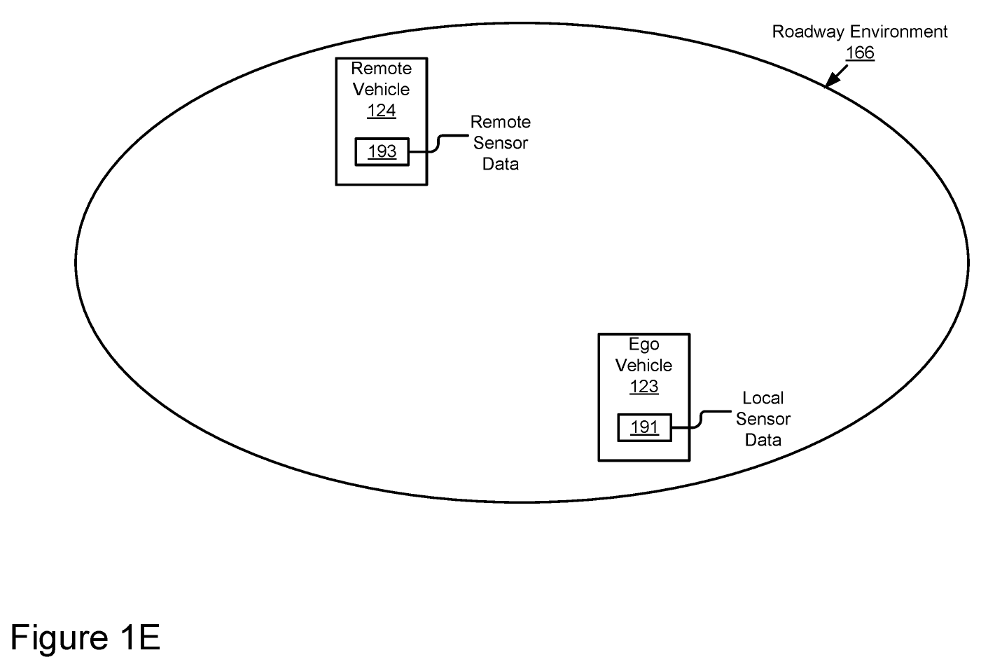

Referring to FIG. 1A, depicted is an operating environment 100 for a sensor decision system 199. The operating environment 100 may include one or more of the following elements: an ego vehicle 123; a remote vehicle 124; a roadside unit 104 (“RSU 104”); and a server 103. These elements of the operating environment 100 may be communicatively coupled to a network 105.

In some embodiments, the server 103 may be an element of the RSU 104. In some embodiments, the server 103 may be a separate element. For example, the server 103 may be a server or some other processor-based computing device that is operable to send and receive messages via the network 105. The RSU 104 and the server 103 are described in more detail below.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, etc. The network 105 may also include a mobile data network that may include 3G, 4G, LTE, VoLTE or any other cellular network, mobile data network or combination of mobile data networks. Further, the network 105 may include one or more IEEE 802.11 wireless networks.

In some embodiments, one or more of the ego vehicle 123, the remote vehicle 124, the RSU 104 and the server 103 may be DSCR-equipped. The network 105 may include one or more communication channels shared among the ego vehicle 123 and one or more other wireless communication devices (e.g., one or more remote vehicles 124, RSUs 104, servers 103, etc.). The communication channel may include DSRC, full-duplex wireless communication or any other wireless communication protocol. For example, the network 105 may be used to transmit a DSRC message, DSRC probe or BSM including remote sensor data 193 to the ego vehicle 123.

The ego vehicle 123 and the remote vehicle 124 may include the same or similar elements. The ego vehicle 123 and the remote vehicle 124 may share a connection or association. For example, the ego vehicle 123 and the remote vehicle 124 may share a common manufacturer (e.g., Toyota) and the functionality described herein may only be provided to vehicles having this common manufacturer.

The ego vehicle 123 may include a car, a truck, a sports utility vehicle, a bus, a semi-truck, a drone or any other roadway-based conveyance. In some embodiments, the ego vehicle 123 may include an autonomous vehicle or a semi-autonomous vehicle. For example, the ego vehicle 123 may include an ADAS system.

The ego vehicle 123 may include one or more of the following elements: a sensor set 182; a processor 125; a memory 127; a communication unit 145; a DSRC-compliant GPS unit 170; an ADAS system 180; and a sensor decision system 199. These elements of the ego vehicle 123 may be communicatively coupled to one another via a bus 120.

In some embodiments, the processor 125 and the memory 127 may be elements of an onboard vehicle computer system (not pictured). The onboard vehicle computer system may be operable to cause or control the operation of the sensor decision system 199. The onboard vehicle computer system may be operable to access and execute the data stored on the memory 127 to provide the functionality described herein for the sensor decision system 199 or its elements.

The sensor set 182 may include one or more sensors that are operable to measure the physical environment outside of the ego vehicle 123. For example, the sensor set 182 may record one or more physical characteristics of the physical environment that is proximate to the ego vehicle 123.

In some embodiments, the sensor set 182 may include one or more of the following vehicle sensors: a camera; a LIDAR sensor; a laser altimeter; a navigation sensor (e.g., a global positioning system sensor of the DSRC-compliant GPS unit 170); an infrared detector; a motion detector; a thermostat; a sound detector, a carbon monoxide sensor; a carbon dioxide sensor; an oxygen sensor; a mass air flow sensor; an engine coolant temperature sensor; a throttle position sensor; a crank shaft position sensor; an automobile engine sensor; a valve timer; an air-fuel ratio meter; a blind spot meter; a curb feeler; a defect detector; a Hall effect sensor, a manifold absolute pressure sensor; a parking sensor; a radar gun; a speedometer; a speed sensor; a tire-pressure monitoring sensor; a torque sensor; a transmission fluid temperature sensor; a turbine speed sensor (TSS); a variable reluctance sensor; a vehicle speed sensor (VSS); a water sensor; a wheel speed sensor; and any other type of automotive sensor.

The sensor set 182 may be operable to record data (optionally referred to herein as “sensor data”) that describes one or more locations of the ego vehicle 123 at one or more different times; this data may be timestamped to indicate the time when the ego vehicle 123 was at this particular location.

The processor 125 includes an arithmetic logic unit, a microprocessor, a general purpose controller, or some other processor array to perform computations and provide electronic display signals to a display device. The processor 125 processes data signals and may include various computing architectures including a complex instruction set computer (CISC) architecture, a reduced instruction set computer (RISC) architecture, or an architecture implementing a combination of instruction sets. Although FIG. 1A includes a single processor 125, multiple processors may be included. Other processors, operating systems, sensors, displays, and physical configurations may be possible.

The memory 127 stores instructions or data that may be executed by the processor 125. The instructions or data may include code for performing the techniques described herein. The memory 127 may be a dynamic random access memory (DRAM) device, a static random access memory (SRAM) device, flash memory, or some other memory device. In some embodiments, the memory 127 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

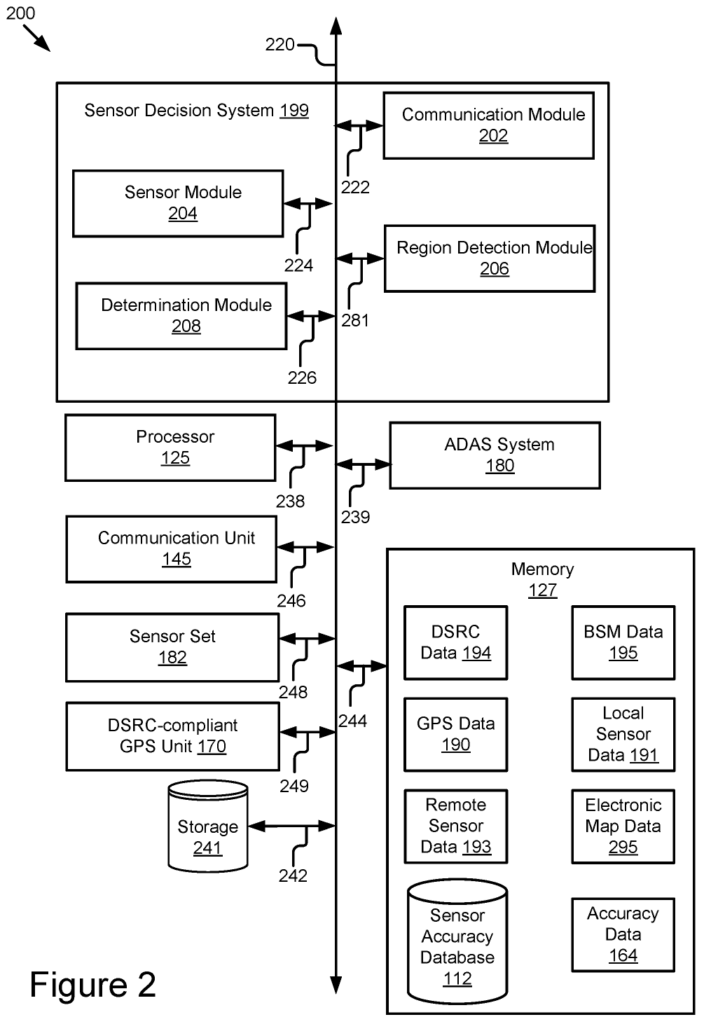

As illustrated in FIG. 1A, in some embodiments the memory 127 stores one or more of the following elements: the local sensor data 191; the Global Positioning System data 190 (herein “GPS data 190”); the sensor accuracy database 112; and the electronic map 195. The memory 127 may also store one or more of the remote sensor data 193, BSM data (see, e.g., element 195 of FIGS. 2, 4A and 4B) and DSRC data (see, e.g., element 194 of FIG. 2). In some embodiments, the remote sensor data 193 may be an element of the BSM data or the DSRC data. For example, the remote sensor data 193 may be included in a BSM or DSRC message received by the communication unit 145.

The local sensor data 191 may describe sensor measurements recorded by one or more sensors of the sensor set 182 of the ego vehicle 123. For example, the local sensor data 191 may describe one or more measurable characteristics of a roadway environment that includes the ego vehicle 123.

The remote sensor data 193 may describe sensor measurements recorded by one or more sensors of a sensor set of the remote vehicle 124 or the RSU 104. For example, the remote sensor data 193 may describe one or more measurable characteristics of a roadway environment that includes the ego vehicle 123 and one or more of the remote vehicle 124 and the RSU 104.

The GPS data 190 may describe the location of the ego vehicle 123 at a given time. The GPS data 190 may be generated by the DSRC-compliant GPS unit 170. The GPS data 190 may describe a latitude and a longitude of the ego vehicle. The accuracy of the GPS data 190 may be compliant with the DSRC standard. As described below with reference to the electronic map 195 and the electronic map data 295 (see, e.g., FIG. 2), different geographic locations described by the GPS data 190 may be associated with different region identifiers (herein, “region ID” if singular, or “region IDs” if plural).

Each region ID may be uniquely associated with a geographical region. For example, a map may depict a geographical area that includes a plurality of geographical regions, and a region ID may be uniquely associated with a particular geographical region included in the map. The GPS data 190 for the ego vehicle 123 may indicate that the ego vehicle 123 is located within a particular geographical region, and the latitude and longitude described by the GPS data 190 may be associated with the region ID that is assigned to the particular geographical region where the ego vehicle 123 is located.

The sensor accuracy database 112 may include accuracy data. The accuracy data may describe one or more geographical constraints that affect to the accuracy of one or more of the local sensor data 191 and remote sensor data 193 for different geographic regions.

Examples of geographical constraints that may affect whether the local sensor data 191 or remote sensor data 193 will be more accurate include the following: the curvature effects to the accuracy of a forward sensor of the ego vehicle 123 (e.g., a sensor of the sensor set 182 that measures the physical environment in front of the ego vehicle 123 or substantially in front of the ego vehicle 123); a number of base stations in the geographic area where the ego vehicle 123 is located; and the degree of signal interference and how this interference may affect the ability of the ego vehicle 123 to receive remote sensor data 193 via wireless transmission from one or more remote vehicles 124 or the RSU 104 (e.g., signal interference that impedes the performance or availability of the network 105 or a wireless communication signal of the network 105).

As mentioned in the preceding paragraph, the accuracy data may include geographical constraints for a plurality of geographical regions. Each geographical region described by the accuracy data may be assigned a region ID. Within the accuracy data, each region ID may be associated with one or more geographical constraints. These geographical constraints may describe one or more factors which affect the accuracy of the local sensor data or the remote sensor data when the vehicle is present in this particular geographic region. For example, a particular geographical region may be near the ocean, and so, the accuracy data for this particular geographical region may include a geographical constraint indicating high signal interference because the ocean adversely affects the performance of wireless communication (meaning that at least one factor indicates that local sensor data 191 is more accurate that remote sensor data 193 for this particular geographical region; other factors may outweigh or confirm this particular factor).

The electronic map 195 may include one or more electronic maps for a particular geographical area. Each geographical area may include a plurality of geographical regions. Each geographical region may include a set of latitudes and longitudes that are within that geographical region. The electronic map 195 may be described by electronic map data 295 (which is not depicted in FIG. 1A, but is depicted in FIG. 2).

The electronic map 195 may be configured so that it is operable to receive a query including GPS data 190 describing a combination of latitude and longitude as an input, and then output a region ID associated with that GPS data 190 as a response to the query. For example, the GPS data 190 may describe a latitude and longitude where the ego vehicle 123 is located.

The GPS data 190 may be provided to the electronic map 195 by the sensor decision system 199 as an input. The electronic map 195 or the sensor decision system 199 may include code and routines that are operable, when executed by the processor 125, to cause the processor 125 to perform one or more of the following steps: (1) identify which geographical region includes the latitude and longitude described by the GPS data 190; (2) identify the region ID for the geographical region that includes the latitude and longitude described by the GPS data 190; and (3) output data describing a region ID that is associated with the geographical region that includes the latitude and longitude described by the GPS data 190.

The communication unit 145 transmits and receives data to and from a network 105 or to another communication channel. In some embodiments, the communication unit 145 may include a DSRC transceiver, a DSRC receiver and other hardware or software necessary to make the ego vehicle 123 a DSRC-enabled device.

In some embodiments, the communication unit 145 includes a port for direct physical connection to the network 105 or to another communication channel. For example, the communication unit 145 includes a USB, SD, CAT-5, or similar port for wired communication with the network 105. In some embodiments, the communication unit 145 includes a wireless transceiver for exchanging data with the network 105 or other communication channels using one or more wireless communication methods, including: IEEE 802.11; IEEE 802.16, BLUETOOTH®; EN ISO 14906:2004 Electronic Fee Collection—Application interface EN 11253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); the communication method described in U.S. patent application Ser. No.14/471,387 filed on Aug. 28, 2014 and entitled “Full-Duplex Coordination System”; or another suitable wireless communication method.

In some embodiments, the communication unit 145 includes a full-duplex coordination system as described in U.S. patent application Ser. No. 14/471,387 filed on Aug. 28, 2014 and entitled “Full-Duplex Coordination System.”

In some embodiments, the communication unit 145 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some embodiments, the communication unit 145 includes a wired port and a wireless transceiver. The communication unit 145 also provides other conventional connections to the network 105 for distribution of files or media objects using standard network protocols including TCP/IP, HTTP, HTTPS, and SMTP, millimeter wave, DSRC, etc.

The DSRC-compliant GPS unit 170 may include hardware that wirelessly communicates with a GPS satellite to retrieve GPS data 190 that describes a location of the ego vehicle 123. In some embodiments, a DSRC-compliant GPS unit 170 is operable to provide GPS data 190 that describes the location of the ego vehicle 123 to a lane-level degree of precision. The DSRC standard requires that GPS data 190 be precise enough to infer if two vehicles (such as ego vehicle 123 and another vehicle on the same roadway as the ego vehicle 123) are in the same lane. The DSRC-compliant GPS unit 170 may be operable to identify, monitor and track its two-dimensional position within 1.5 meters of its actual position 68% of the time under an open sky. Since lanes of a roadway are typically no less than 3 meters wide, whenever the two-dimensional error of the GPS data 190 is less than 1.5 meters the sensor decision system 199 or the electronic map 195 may analyze the GPS data 190 provided by the DSRC-compliant GPS unit 170 and determine what lane of the roadway the ego vehicle 123 is traveling in based on the relative positions of vehicles on the roadway.

By comparison, a GPS unit which is not compliant with the DSRC standard is far less accurate than the DSRC-compliant GPS unit 170 and not capable of reliably providing lane-level accuracy, as is the DSRC-compliant GPS unit 170. For example, a non-DSRC-compliant GPS unit may have an accuracy on the order of 10 meters, which is not sufficiently precise to provide the lane-level degree of precision provided by the DSRC-compliant GPS unit 170. For example, since a lane may be as narrow as 3 meters wide, the DSRC standard may require a DSRC-compliant GPS unit 170 to have an accuracy on the order of 1.5 meters, which is significantly more precise than a non-DSRC-compliant GPS unit as described above. As a result, a non-DSRC-compliant GPS unit may not be able to provide GPS data 190 that is accurate enough to enable the sensor decision system 199 or the electronic map 195 to precisely identify which geographical region the ego vehicle 123 is located in when the ego vehicle 123 is within 1.5 meters of a boarder that separates one geographical region from another geographical region. In the aggregate, these border regions occupy a large and significant area where the sensor decision system 199 would be rendered inoperable. The imprecision of a non-DSRC-compliant GPS unit may therefore render the functionality of the sensor decision system 199 inoperable. The functionality and precision provided by the DSRC-compliant GPS unit 170 is therefore beneficial for this example reason.

The ADAS system 180 may include one or more advanced driver assistance systems. Examples of an ADAS system 180 may include one or more of the following elements of an ego vehicle 123: an ACC system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane departure warning system; a pedestrian protection system; a traffic sign recognition system; a turning assistant; and a wrong-way driving warning system.

In some embodiments, the ADAS system 180 includes any hardware or software that controls one or more operations of the ego vehicle 123 so that the ego vehicle 123 is “autonomous” or “semi-autonomous.”

In some embodiments, the sensor decision system 199 may include code or routines that build and transmit a wireless message to the network 105 that includes remote sensor data 193. For example, the remote vehicle 124, RSU 104 or server 103 may include a sensor decision system 199 that causes a wireless message including the remote sensor data 193 to be transmitted to the ego vehicle 123. The wireless message may include a DSRC message, a DSRC probe, a BSM or a full-duplex wireless message or any other type of wireless message transmitted via any other wireless communication method or protocol. The communication unit 145 of the ego vehicle 123 may receive the wireless message including the remote sensor data 193.

In some embodiments, the communication unit 145 may provide the remote sensor data to the sensor decision system 199 or store the remote sensor data 193 on the memory 127. The communication unit 145 is described below according to some embodiments. The memory 127 is also described below according to some embodiments.

In some embodiments, the sensor decision system 199 may be implemented using hardware including a field-programmable gate array (“FPGA”) or an application-specific integrated circuit (“ASIC”). In some other embodiments, the sensor decision system 199 may be implemented using a combination of hardware and software. The sensor decision system 199 may be stored in a combination of the devices (e.g., servers or other devices), or in one of the devices.

The sensor decision system 199 is described in more detail below with reference to FIGS. 1D, 2, 3 and 5.

Although not depicted in FIG. 1A, in some embodiments the ego vehicle 123 may include a full-duplex coordination system as described in U.S. patent application Ser. No. 14/471,387 filed on Aug. 28, 2014 and entitled “Full-Duplex Coordination System.”

In some embodiments, the full-duplex coordination system of the ego vehicle 123 may receive a full-duplex wireless message that includes the remote sensor data 193.

The server 103 may include a processor based computing device. For example, the computing device may include a standalone hardware server. In some embodiments, the server 103 may be communicatively coupled to the network 105. The server 103 may include network communication capabilities.

The server 103 may be operable to send and receive wireless messages via the network 105. For example, the sensor accuracy database 112 may be deployed on the server 103 instead of within the local memory 127 of the ego vehicle 123, and the communication unit 145 may provide a query to the sensor accuracy database 112 via the network. The query may include a region ID and the sensor accuracy database 112 may identify accuracy data that corresponds to the region ID. The sensor accuracy database 112 may transmit a reply to the communication unit 145 via the network. The reply may include the accuracy data that is associated with the region ID included in the query

The remote vehicle 124 may include elements similar to the ego vehicle 123, and so, those descriptions will not be repeated here.

The RSU 104 may include a non-transitory memory that stores remote sensor data 193 and a sensor decision system 199. The RSU 104 also includes a communication unit 145 (not pictured). The RSU 104 may also include a sensor set 182 that records the remote sensor data 193. In the alternative to recording the remote sensor data 193 directly using its own sensor set 182, the RSU 104 may relay remote sensor data 193 from the remote vehicle 124 to the ego vehicle 123. For example, if the ego vehicle 123 is outside of communication range of the remote vehicle 124, then the RSU 104 may relay a wireless message including the remote sensor data 193 to the ego vehicle 123.

Referring now to FIG. 1B, depicted is a block diagram illustrating the sensor accuracy database 112 according to some embodiments. The columns of the sensor accuracy database 112 are labeled at the bottom with the letters (a), (b), (c), (d) and (e) to show how the sensor accuracy database corresponds to the equations depicted in FIG. 1C.

Referring now to FIG. 1C, depicted is a block diagram illustrating the accuracy data 164 according to some embodiments. Each instance of accuracy data 164 is associated with a unique region ID. The accuracy data 164 for a particular geographical region may include a pair of associated probabilities that indicate whether the local sensor data 191 or the remote sensor data 193 is more accurate while the ego vehicle 123 is located within that particular geographical region.

For example, the accuracy data 164 may include data describing a probability 160 that the local sensor data 191 is more accurate than the remote sensor data 193 while the ego vehicle 123 is present in the geographical region associated with that region ID. The accuracy data 164 may also include data describing a probability 162 that the remote sensor data 193 is more accurate than the local sensor data 191 while the ego vehicle 123 is present in the geographical region associated with that region ID. If probability 160 is greater than probability 162 for a particular region ID, then the local sensor data 191 is more accurate than the remote sensor data 193 while the ego vehicle 123 is present in the geographical region associated with that particular region ID. If probability 162 is greater than probability 160 for the region ID, then the remote sensor data 193 is more accurate than the local sensor data 191 while the ego vehicle 123 is present in the geographical region associated with that particular region ID.

In some embodiments, the local sensor data 191 and the remote sensor data 193 stored in the memory 127 of the ego vehicle 123 may be encoded with data (e.g., GPS data 190 or a timestamp) that indicates the geographical region where the local sensor data 191 or the remote sensor data 193 was recorded. In this way the sensor decision system 199 may determine which instances of local sensor data 191 or remote sensor data 193 are subject to the accuracy indicated by the accuracy data 164. In some embodiments, the determination of the accuracy data 164 occurs in real time or near real time relative to recordation of the local sensor data 191 and receipt of the remote sensor data 193 so that such data indicative of geographical region is not encoded in the local sensor data 191 or the remote sensor data 193 since the geographical region associated with the local sensor data 191 and the remote sensor data 193 may be accurately assumed to be the geographical region where the ego vehicle 123 is presently located.

Referring now to FIG. 1D, depicted is a block diagram illustrating a flow process 111 implemented by the sensor decision system 199 according to some embodiments.

In some embodiments, a DSRC-compliant GPS unit 170 may provide GPS data 190 describing a geographic location of the ego vehicle 123 to the sensor decision system 199. The sensor decision system 199 may provide this GPS data 190 as an input to the electronic map 195. The electronic may 195 may receive the GPS data 190 as an input and output to the sensor decision system 199 a response including data describing the region ID associated with the GPS data 190 that was received as an input. The sensor decision system 199 may provide the data describing the region ID to the sensor accuracy database 112 as an input. The sensor accuracy database 112 may receive the data describing the region ID as an input and output to the sensor decision system an instance of accuracy data 164 that is associated with the region ID that was received as an input. The sensor decision system 199 may analyze the accuracy data 164 and determine whether to use local sensor data 191 or remote sensor data 193 while the ego vehicle 123 is located in the geographical region associated with the region ID based on the accuracy data 164.

Referring now to FIG. 1E, depicted is a block diagram illustrating a roadway environment 166 including a remote vehicle 124 and an ego vehicle 123 according to some embodiments. One or more of the remote vehicle 124 and the ego vehicle may include a sensor decision system 199. The roadway environment 166 may include other elements such as a roadway, traffic signs, traffic signals, businesses, RSUs, etc. Although one remote vehicle 124 and one ego vehicle 123 are depicted in FIG. 1E, in practice any positive whole number of remote vehicles 124 and any positive whole number of ego vehicles 123 may be present in the roadway environment 166.

Referring now to FIG. 2, depicted is a block diagram illustrating an example computer system 200 including a sensor decision system 199 according to some embodiments.

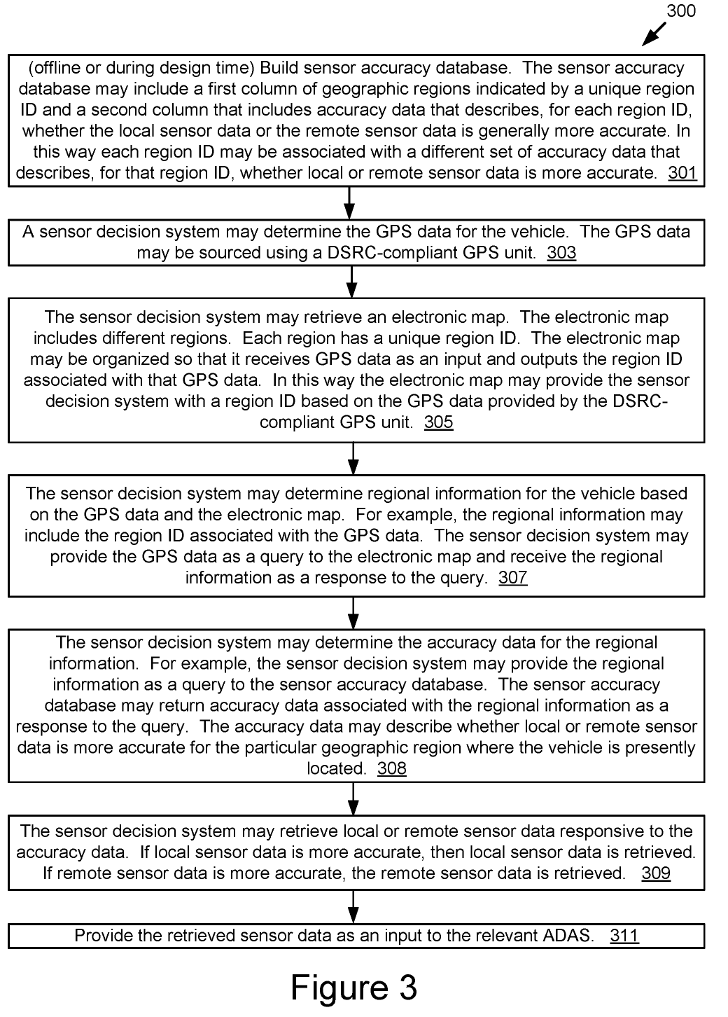

In some embodiments, the computer system 200 may include a special-purpose computer system that is programmed to perform one or more steps of a method 300 described below with reference to FIG. 3 or the flow process 111 described above with reference to FIG. 1D.

In some embodiments, the computer system 200 may be an element of one or more of the following devices: the ego vehicle 123; the server 103; the RSU 104; and the remote vehicle 124.

In some embodiments, the computer system 200 may be an onboard vehicle computer of a device such as one or more of the following: the ego vehicle 123; the server 103, the RSU 104; and the remote vehicle 124.

In some embodiments, the computer system 200 may include an engine control unit, head unit or some other processor-based computing device of the ego vehicle 123 or the remote vehicle 124.

The computer system 200 may include one or more of the following elements according to some examples: the sensor decision system 199; the processor 125; the communication unit 145; the sensor set 182; the DSRC-compliant GPS unit 170; the ADAS system 180; the memory 127; and a storage 241. The components of the computer system 200 are communicatively coupled by a bus 220.

In the illustrated embodiment, the processor 125 is communicatively coupled to the bus 220 via a signal line 238. The communication unit 145 is communicatively coupled to the bus 220 via a signal line 246. The sensor set 182 is communicatively coupled to the bus 220 via a signal line 248. A DSRC-compliant GPS unit 170 is communicatively coupled to the bus 220 via a signal line 249. The ADAS system 180 is communicatively coupled to the bus 220 via a signal line 239. The storage 241 is communicatively coupled to the bus 220 via a signal line 242. The memory 127 is communicatively coupled to the bus 220 via a signal line 244.

The following elements of the computer system 200 were described above with reference to FIG. 1A, and so, those descriptions will not be repeated here: the sensor decision system 199; the processor 125; the communication unit 145; the sensor set 182; the DSRC-compliant GPS unit 170; the ADAS system 180; and the memory 127.

As illustrated in FIG. 2, the memory 127 stores one or more of the following elements: the DSRC data 194; the BSM data 195; electronic map data 295; the GPS data 190; the local sensor data 191; the remote sensor data 193; the sensor accuracy database 112; and the accuracy data 164 (which may be an element of the sensor accuracy database 112).

The following elements of the memory 127 were described above with reference to FIGS. 1A-1E, and so, these descriptions will not be repeated here: the GPS data 190; the local sensor data 191; the remote sensor data 193; the sensor accuracy database 112; and the accuracy data 164.

The DSRC data 194 may include any data included in a DSRC message. The DSRC data 194 may be received by the communication unit 145 as an element of a DSRC message. For example, the DSRC data 194 may be encoded in the DSRC message. The DSRC data 194 may be included in a DSRC message built by the communication module 202 and transmitted to the network 105 by the communication unit 145. Any of the data stored in the memory 127 may be included in the DSRC data 194.

The BSM data 195 may include any data included in a BSM. The BSM data 195 may be received by the communication unit 145 as an element of a BSM. The BSM data 195 may be encoded in a BSM. The BSM data 195 may be included in a BSM built by the communication module 202 and transmitted to the network 105 by the communication unit 145. Any of the data stored in the memory 127 may be included in the BSM data 195.

The electronic map data 295 may describe the electronic map 195.

The storage 241 can be a non-transitory storage medium that stores data for providing the functionality described herein. The storage 241 may be a dynamic random access memory (DRAM) device, a static random access memory (SRAM) device, flash memory, or some other memory devices. In some embodiments, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In the illustrated embodiment shown in FIG. 2, the sensor decision system 199 includes a communication module 202, a sensor module 204, a region detection module 206 and a determination module 208. These components of the sensor decision system 199 are communicatively coupled to each other via a bus 220. In some embodiments, components of the sensor decision system 199 can be stored in a single server or device. In some other embodiments, components of the sensor decision system 199 can be distributed and stored across multiple servers or devices. For example, some of the components of the sensor decision system 199 may be distributed across the server 103 and the ego vehicle 123.

The communication module 202 can be software including routines for handling communications between the sensor decision system 199 and other components of the computer system 200. In some embodiments, the communication module 202 can be a set of instructions executable by the processor 125 to provide the functionality described below for handling communications between the sensor decision system 199 and other components of the computer system 200.

The communication module 202 sends and receives data, via the communication unit 145, to and from one or more elements of the operating environment 100 or the flow process 111. For example, the communication module 202 receives or transmits, via the communication unit 145, one or more of the following elements: the DSRC data 194; the BSM data 195; the GPS data 190; the local sensor data 191; the remote sensor data 193; the electronic map data 295; and the accuracy data 164.

In some embodiments, the communication module 202 receives data from components of the sensor decision system 199 and stores the data in one or more of the storage 241 and the memory 127. For example, the communication module 202 receives any of the data described above with reference to the memory 127 the communication unit 145 (via the network 105, a DSRC message, a BSM, a DSRC probe, a full-duplex wireless message, etc.) and stores this data in the memory 127 (or temporarily in the storage 241 which may act as a buffer).

In some embodiments, the communication module 202 may handle communications between components of the sensor decision system 199. For example, the communications module 202 may handle communications among the sensor module 204, the region detection module 206 and the determination module 208. Any of these modules may cause the communication module 202 to communicate with the other elements of the computer system 200.

For example, the sensor module 204 may use the communication module 202 to communicate with the sensor set 182 and cause the sensor set 182 to record the local sensor data 191. The region detection module 206 may use the communication module 202 to communicate with the DSRC-compliant GPS unit 170 and cause the DSRC-compliant GPS unit 170 to retrieve GPS data 190. The region detection module 206 may use the communication module 202 to communicate with the electronic map 195 to provide the GPS data 190 to the electronic map 195 and receive, from the electronic map 195, the region ID that corresponds to the GPS data 190. The determination module 208 may use the communication module 202 to communicate with the sensor accuracy database 112 and provide the region ID to the sensor accuracy database 112 and receive, from the sensor accuracy database 112, accuracy data 164 that corresponds with the region ID.

In some embodiments, the communication module 202 can be stored in the memory 127 of the computer system 200 and can be accessible and executable by the processor 125. The communication module 202 may be adapted for cooperation and communication with the processor 125 and other components of the computer system 200 via signal line 222.

The sensor module 204 can be software including routines for using one or more of the sensors included in the sensor set 182 to generate the local sensor data 191. For example, the sensor module 204 may include code and routines that, when executed by the processor 125, cause the processor 125 to operate one or more of the sensors included in the sensor set 182 to record measurements of the physical environment proximate to the computer system 200 (e.g., the roadway environment 166).

In some embodiments, the sensor module 204 may generate local sensor data 191 describing the measurements of the sensor set 182. The sensor module 204 may cause the local sensor data 191 to be stored in the memory 127.

In some embodiments, the communication unit 145 may receive remote sensor data 193 from the network 105 and the sensor module 204 may cause the communication module 202 to store the remote sensor data 193 in the memory.

In some embodiments, the sensor module 204 may include code and routines that are operable, when executed by the processor 125, to cause the processor 125 to execute one or more of the following steps: (1) execute one or more sensor of the sensor set 182 to generate the local sensor data 191; (2) store the local sensor data 191 in the memory 127; (3) query the communication unit 145 to receive remote sensor data 193 generated by one or more sensors of one or more remote vehicles 124 or one or more RSUs 104; and (4) store the remote sensor data 193 in the memory 127.

In some embodiments, the sensor module 204 can be stored in the memory 127 of the computer system 200 and can be accessible and executable by the processor 125. The sensor module 204 may be adapted for cooperation and communication with the processor 125 and other components of the computer system 200 via the signal line 224.

The region detection module 206 can be software including routines that, when executed by the processor 125, cause the processor 125 to implement one or more of the following steps: (1) executing the DSRC-compliant GPS unit 170 to cause it to retrieve GPS data 190 that describes the current location of the compute system 200; (2) communicate with the electronic map 195 described by the electronic map data 295 to determine which region ID is associated with the latitude and longitude coordinates described by the GPS data 190; (3) query the sensor accuracy database 112 using the region ID to determine accuracy data 164 associated with the region ID; and (4) provide the accuracy data 164 to the determination module 208.

In some embodiments, the region detection module 206 can be stored in the memory 127 of the computer system 200 and can be accessible and executable by the processor 125. The region detection module 206 may be adapted for cooperation and communication with the processor 125 and other components of the computer system 200 via signal line 281.

The determination module 208 can be software including routines that, when executed by the processor 125, cause the processor 125 to implement one or more of the following steps: (1) receive the accuracy data 164 from the region detection module 206; (2) determine, based on the accuracy data 164, whether the local sensor data 191 or the remote sensor data 193 is more accurate for the present geographic location of the compute system 200; and (3) provide the most accurate of the local sensor data 191 and the remote sensor data 193 to the ADAS system 180. The ADAS system 180 may then be executed to provide its functionality based on the local sensor data 191 or the remote sensor data 193 received from the determination module 208.

In some embodiments, if the accuracy data 164 indicates that the local sensor data 191 and the remote sensor data 193 are equally accurate (or substantially equal), the determination module 208 may decide to provide the local sensor data 191 to the ADAS system 180.

In some embodiments, the determination module 208 can be stored in the memory 127 of the computer system 200 and can be accessible and executable by the processor 125. The determination module 208 may be adapted for cooperation and communication with the processor 125 and other components of the computer system 200 via signal line 226.

Referring now to FIG. 3, depicted is a flowchart of an example method 300, according to some embodiments, for determining whether local sensor data or remote sensor data is more accurate based on a geographic location of a vehicle, according to some embodiments. One or more of the steps described herein for the method 300 may be executed by one or more sensor decision systems.

At step 301, the sensor accuracy database is built. The sensor accuracy database may include a first column of geographic regions indicated by a unique region ID and a second column that includes accuracy data that describes, for each region ID, whether the local sensor data or the remote sensor data is generally more accurate. In this way each region ID may be associated with a different set of accuracy data that describes, for that region ID, whether local or remote sensor data is more accurate.

At step 303, the GPS data for the vehicle is determined. The GPS data may be sourced using a DSRC-compliant GPS unit.

At step 305, an electronic map is retrieved. The electronic map includes different regions. Each region has a unique region ID. The electronic map may be organized so that it receives GPS data as an input and outputs the region ID associated with that GPS data. In this way the electronic map may provide the sensor decision system with a region ID based on the GPS data provided by the DSRC-compliant GPS unit.

At step 307, regional information for the vehicle is determined based on the GPS data and the electronic map. For example, the regional information may include the region ID associated with the GPS data. The sensor decision system may provide the GPS data as a query to the electronic map and receive the regional information as a response to the query.

At step 308, the regional information is provided as a query to the sensor accuracy database. The sensor accuracy database returns accuracy data associated with the regional information as a response to the query. The accuracy data may describe whether local or remote sensor data is more accurate for the particular geographic region where the vehicle is presently located.

At step 309, local or remote sensor data is retrieved responsive to the accuracy data. If local sensor data is more accurate, then local sensor data is retrieved. If remote sensor data is more accurate, the remote sensor data is retrieved.

At step 311, the retrieved sensor data is provided as an input to a relevant ADAS. The vehicle may include a plurality of ADAS systems, and a relevant ADAS may include the ADAS that is about to operate and requires sensor data for its operation. There may be a plurality of relevant ADAS systems at any given time.

Referring now to FIG. 4A, depicted is a block diagram illustrating an example of the BSM data 195 according to some embodiments.

The regular interval for transmitting BSMs may be user configurable. In some embodiments, a default setting for this interval may be transmitting the BSM every 0.10 seconds or substantially every 0.10 seconds.

A BSM may be broadcasted over the 5.9 GHz DSRC band. DSRC range may be substantially 1,000 meters. In some embodiments, DSRC range may include a range of substantially 100 meters to substantially 1,000 meters.

Referring now to FIG. 4B, depicted is a block diagram illustrating an example of BSM data 195 according to some embodiments.

A BSM may include two parts. These two parts may include different BSM data 195 as shown in FIG. 4B.

Part 1 of the BSM data 195 may describe one or more of the following: vehicle position; vehicle heading; vehicle speed; vehicle acceleration; vehicle steering wheel angle; and vehicle size.

Part 2 of the BSM data 195 may include a variable set of data elements drawn from a list of optional elements. Some of the BSM data 195 included in Part 2 of the BSM are selected based on event triggers, e.g., anti-locking brake system (“ABS”) being activated may trigger BSM data 195 relevant to the ABS system of the vehicle.

In some embodiments, some of the elements of Part 2 are transmitted less frequently in order to conserve bandwidth.

In some embodiments, the BSM data 195 included in a BSM includes current snapshots of a vehicle traveling along a roadway system.

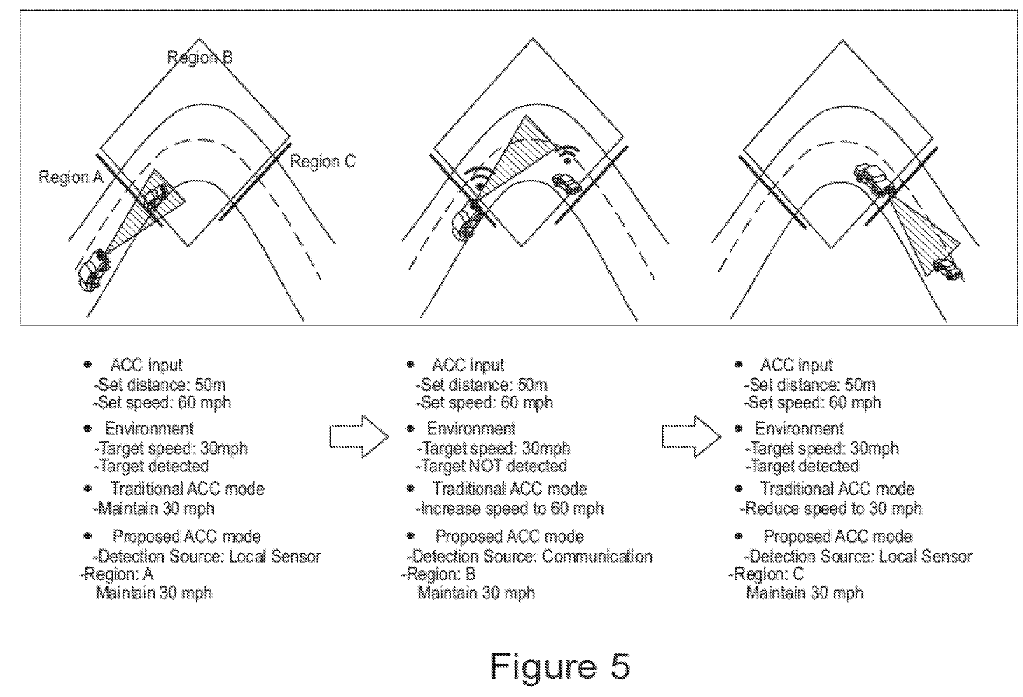

Referring now to FIG. 5, depicted is a block diagram illustrating an example use case of the accuracy data according to some embodiments. The set distance may include the distance that separates the ego vehicle from another vehicle immediately in front of the ego vehicle.

In some embodiments, some or all of the information described above for the BSM data 195 may be included in the DSRC data 194.

One or more of the following devices may be a communication device: an ego vehicle 123; a remote 124; a server 103; and an RSU 104. Regarding U.S. patent application Ser. No. 14/471,387 filed on Aug. 28, 2014 and entitled “Full-Duplex Coordination System,” in a half-duplex communication system, a first communication device currently transmitting data to a second communication device is not capable of simultaneously receiving data from the second communication device. If the second communication device has data to transmit to the first communication device, the second communication device needs to wait until the first communication device completes its data transmission. Only one communication device is allowed to transmit data at one time in the half-duplex communication system.

In a standard IEEE 802.11 Wireless Local Area Network (WLAN), communication devices may compete for access to a wireless channel based on the Carrier Sense Multiple Access with Collision Avoidance (CSMA/CA) Medium Access Control (MAC) protocol. The IEEE 802.11 MAC protocol requires that only one communication device may use the wireless channel to transmit data at one time. If two or more communication devices transmit data over the wireless channel at the same time, a collision occurs. As a result, only the communication device that currently gains access to the wireless channel may use the wireless channel to transmit data. Other communication devices having data to transmit need to monitor the wireless channel and may compete for access to the wireless channel when the wireless channel becomes idle again.

According to one innovative aspect of the subject matter described in this disclosure, the ego vehicle 123 (and other communication devices such as the RSU 104, the remote vehicle 124 or the server 103) may include a full duplex coordination system for implementing full-duplex wireless communications. The full duplex coordination system may include a processor and a memory storing instructions that, when executed, cause the full duplex coordination system to: create, at a first communication device (such as the ego vehicle 123, etc.), first data (such as any combination of the data stored on the memory 127) to transmit to a second communication device (such as a remote vehicle 124, an RSU 104, the server 103, etc.); switch a half-duplex operation mode of the first communication device to a full-duplex operation mode to activate the full-duplex operation mode of the first communication device; transmit a first portion of the first data from the first communication device to the second communication device using a wireless channel; and transmit, in the full-duplex operation mode of the first communication device, a remaining portion of the first data to the second communication device while simultaneously receiving second data (such as any combination of the data stored on the memory 127) from the second communication device using the wireless channel.

According to another innovative aspect of the subject matter described in this disclosure, a full duplex coordination system for implementing full-duplex wireless communications includes a processor and a memory storing instructions that, when executed, cause the full duplex coordination system to: receive a first portion of first data (such as any combination of the data stored on the memory 127) from a first communication device via a wireless channel; determine that a second communication device is a single destination of the first data based on the first portion of the first data; determine that the second communication device has second data (such as any combination of the data stored on the memory 127) to transmit to the first communication device; determine that the first communication device has full-duplex communication capability; switch a half-duplex operation mode of the second communication device to a full-duplex operation mode to activate the full-duplex operation mode of the second communication device; and transmit, in the full-duplex operation mode of the second communication device, the second data to the first communication device while simultaneously receiving a remaining portion of the first data from the first communication device using the wireless channel.

In general, another innovative aspect of the subject matter described in this disclosure may be embodied in methods that include: creating, at a first communication device, first data to transmit to a second communication device; switching a half-duplex operation mode of the first communication device to a full-duplex operation mode to activate the full-duplex operation mode of the first communication device; transmitting a first portion of the first data from the first communication device to the second communication device using a wireless channel; and transmitting, in the full-duplex operation mode of the first communication device, a remaining portion of the first data to the second communication device while simultaneously receiving second data from the second communication device using the wireless channel.

Yet another innovative aspect of the subject matter described in this disclosure may be embodied in methods that include: receiving a first portion of first data from a first communication device via a wireless channel; determining that a second communication device is a single destination of the first data based on the first portion of the first data; determining that the second communication device has second data to transmit to the first communication device; determining that the first communication device has full-duplex communication capability; switching a half-duplex operation mode of the second communication device to a full-duplex operation mode to activate the full-duplex operation mode of the second communication device; and transmitting, in the full-duplex operation mode of the second communication device, the second data to the first communication device while simultaneously receiving a remaining portion of the first data from the first communication device using the wireless channel.

Another innovative aspect of the subject matter described in this disclosure may be embodied in methods that include: determining first data to transmit from a first communication device to a second communication device; and transmitting, from the first communication device that operates in a full-duplex operation mode, the first data to the second communication device while simultaneously receiving second data from the second communication device using a common wireless channel.

Another innovative aspect of the subject matter described in this disclosure may be embodied in methods that include: receiving, from a first communication device, first data at a second communication device via a wireless channel; determining second data to transmit from the second communication device to the first communication device responsive to receiving at least a portion of the first data; and transmitting, from the second communication device that operates in a full-duplex operation mode, the second data to the first communication device using the wireless channel while simultaneously receiving the first data from the first communication device.

Another innovative aspect of the subject matter described in this disclosure may be embodied in methods that include: determining, at a first communication device, first data to transmit to a second communication device; switching the first communication device from a half-duplex operation mode to a full-duplex operation mode; transmitting, in the full-duplex operation mode of the first communication device, the first data to the second communication device while simultaneously receiving second data from the second communication device using the wireless channel; and switching the full-duplex operation mode of the first communication device to the half-duplex operation mode responsive to a determination that transmission of the first data completes.

Another innovative aspect of the subject matter described in this disclosure may be embodied in methods that include: receiving, from a first communication device, first data at a second communication device via a wireless channel; determining that the second communication device has second data to transmit to the first communication device; switching the second communication device from a half-duplex operation mode to a full-duplex operation mode; transmitting, in the full-duplex operation mode of the second communication device, the second data to the first communication device while simultaneously receiving the first data from the first communication device using the wireless channel; and switching the full-duplex operation mode of the second communication device to the half-duplex operation mode responsive to a determination that transmission of the second data completes.

Other aspects include corresponding methods, systems, apparatus, and computer program products for these and other innovative aspects.

These and other embodiments may each optionally include one or more of the following operations and features. For instance, the features include: the first data including a first packet and the first portion of the first data including a header portion of the first packet; the remaining portion of the first data including a payload portion and a trailer portion of the first packet; determining that the second communication device is a single destination of the first data; activating the full-duplex operation mode of the first communication device responsive to the second communication device being the single destination of the first data; the first communication device and the second communication device being communication devices in a wireless local area network; determining that the first communication device operates in a regulated spectrum where full-duplex communication capability is required; receiving device registry data associated with the first communication device; determining that the first communication device has full-duplex communication capability based on the device registry data; and determining that the first communication device has full-duplex communication capability based on a capability indication field in the first portion of the first data, the capability indication field including data describing whether the first communication device has full-duplex communication capability.

For instance, the operations include: determining that the wireless channel is idle; and accessing the wireless channel for data communication between the first communication device and the second communication device based on a channel access rule.

The disclosure is particularly advantageous in a number of respects. For example, the system described herein is capable of achieving a higher throughput and a faster communication speed using full-duplex communication technologies rather than using half-duplex communication technologies. The full-duplex communication may be implemented between vehicles (e.g., one or more full-duplex coordination systems installed in the ego vehicle 123, the remote vehicle 124, the RSU 104, the server 103 such as those depicted in FIG. 1A) or other communication devices that have full-duplex communication capability. In another example, the system coordinates communication between communication devices in a distributed way without using a central coordinator. The system determines a pair of communication devices and coordinates simultaneous transmission of data between the pair of communication devices so that the pair of communication devices may transmit data to each other simultaneously using the same wireless channel. Meanwhile, other communication devices may not transmit data over the wireless channel to avoid collision. The advantages of the system described herein are provided by way of example, and the system may have numerous other advantages.

The disclosure includes a system and method for implementing full-duplex wireless communications between communication devices. A full-duplex coordination system may include a processor and a memory storing instructions that, when executed, cause the full-duplex coordination system to: create, at a first communication device, first data to transmit to a second communication device; switch a half-duplex operation mode of the first communication device to a full-duplex operation mode to activate the full-duplex operation mode of the first communication device; transmit a first portion of the first data from the first communication device to the second communication device using a wireless channel; and transmit, in the full-duplex operation mode of the first communication device, a remaining portion of the first data to the second communication device while simultaneously receiving second data from the second communication device using the wireless channel.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method for an ego vehicle including an Advanced Driving Assistance System (“an ADAS system”), the method comprising:
determining, based on Global Positioning System data (“GPS data”), whether the ego vehicle is located in a geographical region where local sensor data or remote sensor data is more accurate;
retrieving a set of sensor data from a non-transitory memory, wherein the set of sensor data consists of the more accurate of the local sensor data and the remote sensor data;
inputting the set of sensor data to the ADAS system; and
executing the ADAS system so that the ADAS system provides its functionality based on the set of sensor data that consists of the more accurate of the local sensor data and the remote sensor data.

2. The method of claim 1, wherein the remote sensor data is transmitted to the ego vehicle by a remote vehicle.

3. The method of claim 1, wherein the remote sensor data is transmitted to the ego vehicle by a Roadside Unit (“an RSU”).

4. The method of claim 1, wherein the remote sensor data is transmitted to the ego vehicle via a wireless message that is compliant with a Dedicated Short Range Communication (“DSRC”) standard.

5. The method of claim 1, wherein the remote sensor data is transmitted to the ego vehicle via a full-duplex wireless message.

6. The method of claim 1, wherein the remote sensor data is transmitted to the ego vehicle via a millimeter wave message.

7. The method of claim 1, wherein the GPS data is retrieved by a DSRC-compliant GPS unit.

8. The method of claim 1, wherein the GPS data has an accuracy of substantially plus or minus 1.5 meters of the actual location of the ego vehicle.

9. A system including an ego vehicle, the ego vehicle comprising:
an ADAS system; and
an onboard vehicle computer system that is communicatively coupled to the ADAS system, the onboard vehicle computer system including a non-transitory memory storing computer code which, when executed by the onboard vehicle computer system causes the onboard vehicle computer system to:
determine, based on GPS data describing a geographical location of the ego vehicle, whether the ego vehicle is located in a geographical region where local sensor data or remote sensor data is more accurate;
retrieving a set of sensor data from the non-transitory memory, wherein the set of sensor data consists of the more accurate of the local sensor data and the remote sensor data;
inputting the set of sensor data to the ADAS system; and
executing the ADAS system so that the ADAS system provides its functionality based on the set of sensor data that consists of the more accurate of the local sensor data and the remote sensor data.

10. The system of claim 9, wherein the remote sensor data is transmitted to the ego vehicle by a remote vehicle.

11. The system of claim 9, wherein the remote sensor data is transmitted to the ego vehicle by an RSU.

12. The system of claim 9, wherein the remote sensor data is transmitted to the ego vehicle via a wireless message that is compliant with a DSRC standard.

13. The system of claim 9, wherein the remote sensor data is transmitted to the ego vehicle via a full-duplex wireless message.

14. The system of claim 9, wherein the remote sensor data is transmitted to the ego vehicle via a millimeter wave message.

15. The system of claim 9, wherein the remote sensor data is transmitted to the ego vehicle via a wireless network.

16. The system of claim 9, wherein the GPS data has an accuracy of substantially plus or minus 1.5 meters of the actual location of the ego vehicle.

17. A computer program product comprising a non-transitory memory of an onboard vehicle computer system of an ego vehicle storing computer-executable code that, when executed by a processor, causes the processor to:
determine, based on GPS data describing a geographical location of the ego vehicle, whether the ego vehicle is located in a geographical region where local sensor data or remote sensor data is more accurate;
retrieving a set of sensor data from the non-transitory memory, wherein the set of sensor data consists of the more accurate of the local sensor data and the remote sensor data;
input the set of sensor data to an ADAS system of the ego vehicle; and
executing the ADAS system so that the ADAS system provides its functionality based on the set of sensor data that consists of the more accurate of the local sensor data and the remote sensor data.

18. The computer program product of claim 17, wherein the remote sensor data is transmitted to the ego vehicle by a remote vehicle.

19. The computer program product of claim 17, wherein the remote sensor data is generated by a sensor set of a remote vehicle.

20. The computer program product of claim 17, wherein the local sensor data is generated by a sensor set of the ego vehicle.
